(19) United States
(12) Patent Application Publication
(10) Pub. No.: US 2022/0403304 A1
(43) Pub. Date: Dec. 22, 2022

(54) UNIT DOSE PRODUCT COMPRISING A LIQUID COMPOSITION WITH ENCAPSULATED FRAGRANCE

(71) Applicant: Henkel IP & Holding GmbH, Duesseldorf (DE)

(72) Inventors: Wei Sun, Trumbull, CT (US); Jessica McKeon, Trumbull, CT (US); Meghan Russell, Trumbull, CT (US); Brian Alan Warren, Trumbull, CT (US); Rebekah Cathleen Seabury, Trumbull, CT (US); Maxime Pelletier, Rindge, NH (US)

(21) Appl. No.: 17/830,711

(22) Filed: Jun. 2, 2022

Related U.S. Application Data
(60) Provisional application No. 63/202,519, filed on Jun. 15, 2021.

(51) Int. Cl. C11D 17/04; C11D 3/50; C11D 3/43; C11D 3/37

(52) U.S. Cl. CPC C11D 17/045; C11D 3/505; C11D 3/43; C11D 3/3707

(57) ABSTRACT

The present disclosure provides the a fabric treatment unit dose product comprising at least one water-soluble compartment formed by a water-soluble film material and comprising a liquid composition; wherein the liquid composition comprises an encapsulated fragrance slurry, at least one non-aqueous solvent, and a polyethylene glycol with a molecular weight between about 200 and about 1000 Daltons.

### CROSS REFERENCE TO RELATED APPLICATIONS

The present application claims the priority benefit of U.S. Provisional Application No. 63/202,519, filed Jun. 15, 2021, which is hereby incorporated by reference in its entirety.

### FIELD OF DISCLOSURE

The present disclosure relates to unit dose compositions comprising at least one water-soluble compartment enclosing a liquid composition.

### BACKGROUND

Encapsulated fragrances are widely used in laundry detergent and fabric treatment compositions to provide long-lasting freshness performance. Encapsulated fragrance slurry is a mixture of encapsulated fragrance particles, water and stabilizers. Encapsulated fragrance particles comprises a fragrance composition that is encompassed by a shell material. Encapsulated fragrance particles are dispersed in water solution by stabilizers in the slurry which helps to suspend encapsulated fragrance particles and prevent them from physical separation for weeks.

Unit dose laundry products have been very well accepted by consumers due to their convenience. A unit dose product comprising a concentrated amount of encapsulated fragrance slurry provides consumers a desired fragrance performance both with convenience and smaller size that drives sustainability.

However, in order to contain a concentrated encapsulated fragrance slurry inside a water-soluble film material, it is required to introduce non-aqueous solvents to maintain the integrity of the film to prevent issues like leaking or dissolution that leads to poor product quality. However, introducing non-aqueous solvents, such as alcohol-based solvents (e.g. glycerin, propylene glycol), has been found to be detrimental to the stability of an encapsulated fragrance slurry. Thus, there is a need for a formulation containing a concentrated encapsulated fragrance slurry that is stable inside a water-soluble film material.

### BRIEF SUMMARY

In some aspects, provided herein is a fabric treatment unit dose product comprising at least one water-soluble compartment formed by a water-soluble film material, wherein the at least one water-soluble compartment comprises a liquid composition comprises (1) from about 20% by weight to about 50% by weight of an encapsulated fragrance slurry, or (2) from about 5% by weight to about 18% by weight of encapsulated fragrance particles; from about 8% by weight to about 40% by weight of at least one non-aqueous solvent; and from about 20% by weight to about 50% by weight of a polyethylene glycol, wherein the polyethylene glycol has a molecular weight between about 200 and about 1000 Daltons.

In some aspects, provided herein is a fabric treatment unit dose product comprising at least one water-soluble compartment formed by a water-soluble film material, wherein the at least one water-soluble compartment comprises a liquid composition comprising (1) from about 20% by weight to about 70% by weight of an encapsulated fragrance slurry, or (2) from about 5% by weight to about 25% by weight of encapsulated fragrance particles; from about 8% by weight to about 50% by weight of at least one non-aqueous solvent; and from about 10% by weight to about 60% by weight of a polyethylene glycol, wherein the polyethylene glycol has a molecular weight between about 200 and about 1000 Daltons.

In some aspects, provided herein is a liquid composition comprising (1) from about 20% by weight to about 45% by weight of an encapsulated fragrance slurry, or (2) from about 5% by weight to about 15% by weight of encapsulated fragrance particles; from about 8% by weight to about 30% by weight of at least one non-aqueous solvent; and from about 20% by weight to about 50% by weight of a polyethylene glycol, wherein the polyethylene glycol has a molecular weight between about 200 and about 1000 Daltons.

In some aspects, the at least one non-aqueous solvent is selected from the group consisting of ethylene glycol, glycerin, propylene glycol, ethanol, dipropylene glycol, and tripropylene glycol methyl ether.

In some aspects, the liquid composition comprises a first non-aqueous solvent and a second non-aqueous solvent, wherein the first non-aqueous solvent is glycerin.

In some aspects, the second non-aqueous solvent is propylene glycol.

In some aspects, the polyethylene glycol has a molecular weight of about 400 Daltons.

In some aspects, the fabric treatment unit dose product further comprises a second compartment, wherein the second compartment comprises a powder composition, and wherein the powder composition comprises a fragrance composition.

In some aspects, the encapsulated fragrance slurry comprises from about 20% by weight to about 40% by weight of encapsulated fragrance particles.

In some aspects, the liquid composition does not separate into more than one layer for at least 24 hours at room temperature.

### BRIEF DESCRIPTION OF DRAWINGS

FIG. 1 shows the physical stability of two reference samples (B1 and B2) as compared to a liquid composition comprising PEG400 as described herein (B3). The samples were incubated at room temperature for 24 hours.

### DETAILED DESCRIPTION

Provided herein is a fabric treatment unit dose product comprising at least one water-soluble compartment formed by a water-soluble film material and comprising a liquid composition. In some aspects, the liquid composition comprises an encapsulated fragrance slurry, at least one non-aqueous solvent, and a polyethylene glycol with a molecular weight between about 200 and about 1000 Daltons.

Non-limiting examples of the various aspects are shown in the present disclosure.

### I. Definitions

In order that the present disclosure can be more readily understood, certain terms are first defined. Additional definitions are set forth throughout the detailed disclosure.

All of the various aspects, embodiments, and options disclosed herein can be combined in any and all variants unless otherwise specified. Terms in this application control in the event of a conflict with a patent or publication term that is incorporated by reference.

As used herein, “a,” “an,” or “the” means one or more unless otherwise specified.

Furthermore, “and/or”, where used herein, is to be taken as specific disclosure of each of the two specified features or components with or without the other. Thus, the term “and/or” as used in a phrase such as “A and/or B” herein is intended to include “A and B,” “A or B,” “A” (alone), and “B” (alone). Likewise, the term “and/or” as used in a phrase such as “A, B, and/or C” is intended to encompass each of the following aspects: A, B, and C; A, B, or C; A or C; A or B; B or C; A and C; A and B; B and C; A (alone); B (alone); and C (alone).

Open terms such as “include,” “including,” “contain,” “containing” and the like mean “comprising.” The term “or” can be conjunctive or disjunctive.

It is understood that wherever aspects are described herein with the language “comprising,” otherwise analogous aspects described in terms of “consisting of” and/or “consisting essentially of” are also provided.

Some inventive embodiments contemplate numerical ranges. Every numerical range provided herein includes the range endpoints as individual inventive embodiments. When a numerical range is provided, all individual values and sub-ranges therein are present as if explicitly written out.

The term “about” includes the recited number±10%. For example, “about 10” means 9 to 11.

The phrase “substantially free of” means that a composition contains little no specified ingredient/component, such as less than about 5% by weight, less than about 4% by weight, less than about 3% by weight, less than about 2% by weight, or less than about 1% by weight of the specified ingredient.

As used herein, the “%” described in the present application refers to the weight percentage unless otherwise indicated.

The term “at least” prior to a number or series of numbers is understood to include the number adjacent to the term “at least,” and all subsequent numbers or integers that could logically be included, as clear from context. For example, “at least one non-aqueous solvent” means that 1, 2, 3, or more non-aqueous solvents have the indicated property. When at least is present before a series of numbers or a range, it is understood that “at least” can modify each of the numbers in the series or range. “At least” is also not limited to integers (e.g., “at least 5%” includes 5.0%, 5.1%, 5.18% without consideration of the number of significant figures).

Unless states otherwise, the term “by weight of the composition” refers to a composition of a final product derived from a process, unless otherwise defined.

The terms “textile” and “fabric” can be used interchangeably.

The terms “fragrance” and “perfume” can be used interchangeably.

The terms “capsule”, “microcapsule”, and “encapsulate” can be used interchangeably.

The terms “process” and “method” can be used interchangeably.

The term “fragrance encapsulate” refers a core-shell structure which comprises a microcapsule (shell) and a fragrance (core) entrapped in the microcapsule. The weight of a fragrance encapsulate is the sum of the weight of the microcapsule and the weight of the fragrance (core) entrapped in the microcapsule.

The term “encapsulated fragrance slurry” refers a core-shell structure which comprises a microcapsule (shell) and a fragrance (core) entrapped in the microcapsule and the water and other ingredients that compose a commercially available fragrance encapsulated slurry. The weight of an encapsulated fragrance slurry is the sum of the weight of the microcapsule, the weight of the fragrance (core) entrapped in the microcapsule, the weight of the water and the weight of the other ingredients.

The term “encapsulated fragrance” refers a fragrance entrapped in the microcapsule. The weight of an encapsulated fragrance is the weight of the fragrance entrapped in the microcapsule, not including the weight of the microcapsule.

### II. Unit Dose Product

In some aspects, provided herein is a fabric treatment unit dose product comprising at least one water-soluble compartment formed by a water-soluble film material and comprising a liquid composition. In some aspects, the liquid composition comprises from about 20% by weight to about 50% by weight of an encapsulated fragrance slurry or from about 5% by weight to about 18% by weight of encapsulated fragrance particles; from about 8% by weight to about 40% by weight of at least one non-aqueous solvent; and from about 20% by weight to about 50% by weight of a polyethylene glycol with a molecular weight between about 200 and about 1000 Daltons.

In some aspects, provided herein is a fabric treatment unit dose product comprising at least one water-soluble compartment formed by a water-soluble film material and comprising a liquid composition. In some aspects, the liquid composition comprises from about 20% by weight to about 70% by weight of an encapsulated fragrance slurry or from about 5% by weight to about 25% by weight of encapsulated fragrance particles; from about from about 8% by weight to about 50% by weight of at least one non-aqueous solvent; and from about 10% by weight to about 60% by weight of a polyethylene glycol with a molecular weight between 200 and 1000 Daltons.

In some aspects, provided herein is a liquid composition comprising from about 20% by weight to about 45% by weight of an encapsulated fragrance slurry or from about 5% by weight to about 15% by weight of encapsulated fragrance particles; from about 8% by weight to about 30% by weight of at least one non-aqueous solvent; and from about 20% by weight to about 50% by weight of a polyethylene glycol with a molecular weight between about 200 and about 1000 Daltons.

In some aspects, provided herein is a liquid composition comprising from about 20% by weight to about 70% by weight of an encapsulated fragrance slurry. In some aspects, provided herein is a liquid composition comprising from about 20% by weight to about 60% by weight of an encapsulated fragrance slurry. In some aspects, provided herein is a liquid composition comprising from about 20% by weight to about 50% by weight of an encapsulated fragrance slurry. In some aspects, provided herein is a liquid composition comprising from about 20% by weight to about 45% by weight of an encapsulated fragrance slurry. In some aspects, provided herein is a liquid composition comprising from about 20% by weight to about 40% by weight of an encapsulated fragrance slurry. In some aspects, provided herein is a liquid composition comprising from about 20% by weight to about 30% by weight of an encapsulated fragrance slurry. In some aspects, provided herein is a liquid composition comprising from about 30% by weight to about 70% by weight of an encapsulated fragrance slurry. In some aspects, provided herein is a liquid composition comprising from about 40% by weight to about 70% by weight of an encapsulated fragrance slurry. In some aspects, provided herein is a liquid composition comprising from about 50% by weight to about 70% by weight of an encapsulated fragrance slurry. In some aspects, provided herein is a liquid composition comprising from about 60% by weight to about 70% by weight of an encapsulated fragrance slurry. In some aspects, provided herein is a liquid composition comprising from about 30% by weight to about 45% by weight of an encapsulated fragrance slurry.

In some aspects, the liquid composition comprises no less than 20% by weight, no less than 25% by weight, or no less than 30% by weight of an encapsulated fragrance slurry.

In some aspects, the liquid composition comprises about 20% by weight, about 30% by weight, about 40% by weight, about 45% by weight, about 50% by weight, about 60% by weight, about 70% by weight or a range between any two of the preceding values, of an encapsulated fragrance slurry. In some aspects, the liquid composition comprises about 40% by weight of an encapsulated fragrance slurry. In some aspects, the liquid composition comprises about 33.3% by weight of an encapsulated fragrance slurry. In some aspects, the liquid composition comprises about 39% by weight of an encapsulated fragrance slurry.

In some aspects, the liquid composition comprises from about 5% by weight to about 30% by weight of encapsulated fragrance particles. In some aspects, the liquid composition comprises from about 5% by weight to about 25% by weight of encapsulated fragrance particles. In some aspects, liquid composition comprises from about 5% by weight to about 20% by weight of encapsulated fragrance particles. In some aspects, the liquid composition comprises from about 5% by weight to about 15% by weight of encapsulated fragrance particles. In some aspects, liquid composition comprises from about 5% by weight to about 18% by weight of encapsulated fragrance particles. In some aspects, the liquid composition comprises from about 10% by weight to about 30% by weight of encapsulated fragrance particles. In some aspects, the liquid composition comprises from about 10% by weight to about 25% by weight of encapsulated fragrance particles. In some aspects, the liquid composition comprises from about 10% by weight to about 20% by weight of encapsulated fragrance particles. In some aspects, the liquid composition comprises from about 10% by weight to about 15% by weight of encapsulated fragrance particles.

In some aspects, the liquid composition comprises about 5% by weight, about 15% by weight, about 18% by weight, about 25% by weight about 30% by weight, or a range between any two of the preceding values, of encapsulated fragrance particles.

In some aspects, the encapsulated fragrance slurry comprises from about 15% by weight to about 45% by weight of encapsulated fragrance particles. In some aspects, the encapsulated fragrance slurry comprises from about 20% by weight to about 45% by weight of encapsulated fragrance particles. In some aspects, the encapsulated fragrance slurry comprises from about 20% by weight to about 40% by weight of encapsulated fragrance particles. In some aspects, the encapsulated fragrance slurry comprises from about 20% by weight to about 35% by weight of encapsulated fragrance particles. In some aspects, the encapsulated fragrance slurry comprises from about 20% by weight to about 30% by weight of encapsulated fragrance particles. In some aspects, the encapsulated fragrance slurry comprises from about 20% by weight to about 25% by weight of encapsulated fragrance particles. In some aspects, the encapsulated fragrance slurry comprises from about 25% by weight to about 40% by weight of encapsulated fragrance particles. In some aspects, the encapsulated fragrance slurry comprises from about 30% by weight to about 40% by weight of encapsulated fragrance particles. In some aspects, the encapsulated fragrance slurry comprises from about 35% by weight to about 40% by weight of encapsulated fragrance particles. In some aspects, the encapsulated fragrance slurry comprises from about 30% by weight to about 40% by weight of encapsulated fragrance particles. In some aspects, the encapsulated fragrance slurry comprises from about 25% by weight to about 35% by weight of encapsulated fragrance particles.

In some aspects, the liquid composition comprises no less than 5% by weight, no less than 10% by weight, or no less than 15% by weight of encapsulated fragrance particles.

In some aspects, the encapsulated fragrance slurry comprises about 15% by weight, about 20% by weight, about 25% by weight, about 30% by weight, about 35% by weight, about 40% by weight, about 45% by weight, or a range between any two of the preceding values, of encapsulated fragrance particles.

In some aspects, the encapsulated fragrance particles comprises a shell. In some aspects, the shell encapsulates a core material. In some aspects, the core material of the encapsulated fragrance particles includes one or more perfume oils. In some aspects, the shell of the encapsulated fragrance particles is made from synthetic polymeric materials or naturally-occurring polymers. The encapsulated fragrance particles may be any kind of encapsulated fragrance particle disclosed herein or known in the art. In some aspects, the synthetic polymers are derived from petroleum oil, for example. Non-limiting examples of synthetic polymers include nylon, polyethylenes, polyamides, polystyrenes, polyisoprenes, polycarbonates, polyesters, polyureas, polyurethanes, polyureaurethane, polyolefins, polysaccharides, epoxy resins, vinyl polymers, polyacrylates, melamine formaldehyde, gelatin, shellac, water insoluble inorganics, silicone, and mixtures thereof. Natural polymers occur in nature and may often be extracted from natural materials. Non-limiting examples of naturally occurring polymers are silk, wool, gelatin, cellulose, proteins, and combinations thereof.

In some aspects, the mean particle size of encapsulated fragrance particles is between about 1 to about 100 microns. In some aspects, the mean particle size of encapsulated fragrance particles is between about 5 to about 100 microns. In some aspects, the mean particle size of encapsulated fragrance particles is between about 10 to about 100 microns. In some aspects, the mean particle size of encapsulated fragrance particles is between about 20 to about 100 microns. In some aspects, the mean particle size of encapsulated fragrance particles is between about 30 to about 100 microns. In some aspects, the mean particle size of encapsulated fragrance particles is between about 40 to about 100 microns. In some aspects, the mean particle size of encapsulated fragrance particles is between about 50 to about 100 microns. In some aspects, the mean particle size of encapsulated fragrance particles is between about 60 to about 100 microns. In some aspects, the mean particle size of encapsulated fragrance particles is between about 70 to about 100 microns. In some aspects, the mean particle size of encapsulated fragrance particles is between about 80 to about 100 microns. In some aspects, the mean particle size of encapsulated fragrance particles is between about 90 to about 100 microns. In some aspects, the mean particle size of encapsulated fragrance particles is between about 1 to about 90 microns. In some aspects, the mean particle size of encapsulated fragrance particles is between about 1 to about 80 microns. In some aspects, the mean particle size of encapsulated fragrance particles is between about 1 to about 70 microns. In some aspects, the mean particle size of encapsulated fragrance particles is between about 1 to about 60 microns. In some aspects, the mean particle size of encapsulated fragrance particles is between about 1 to about 50 microns. In some aspects, the mean particle size of encapsulated fragrance particles is between about 1 to about 40 microns. In some aspects, the mean particle size of encapsulated fragrance particles is between about 1 to about 30 microns. In some aspects, the mean particle size of encapsulated fragrance particles is between about 1 to about 20 microns. In some aspects, the mean particle size of encapsulated fragrance particles is between about 1 to about 10 microns. In some aspects, the mean particle size of encapsulated fragrance particles is between about 1 to about 5 microns.

In some aspects, the mean particle size of encapsulated fragrance particles is about 1 micron, about 5 microns, about 10 microns, about 20 microns, about 30 microns, about 40 microns, about 50 microns, about 60 microns, about 70 microns, about 80 microns, about 90 microns, about 100 microns, or a range between any two of the preceding values.

In some aspects, the liquid composition comprises from about 10% by weight to about 60% by weight of a polyethylene glycol. In some aspects, the liquid composition comprises from about 20% by weight to about 60% by weight of a polyethylene glycol. In some aspects, the liquid composition comprises from about 20% by weight to about 50% by weight of a polyethylene glycol. In some aspects, the liquid composition comprises from about 25% by weight to about 50% by weight of a polyethylene glycol. In some aspects, the liquid composition comprises from about 30% by weight to about 50% by weight of a polyethylene glycol. In some aspects, the liquid composition comprises from about 35% by weight to about 50% by weight of a polyethylene glycol. In some aspects, the liquid composition comprises from about 40% by weight to about 50% by weight of a polyethylene glycol. In some aspects, the liquid composition comprises from about 45% by weight to about 50% by weight of a polyethylene glycol. In some aspects, the liquid composition comprises from about 20% by weight to about 45% by weight of a polyethylene glycol. In some aspects, the liquid composition comprises from about 20% by weight to about 40% by weight of a polyethylene glycol. In some aspects, the liquid composition comprises from about 20% by weight to about 35% by weight of a polyethylene glycol. In some aspects, the liquid composition comprises from about 20% by weight to about 30% by weight of a polyethylene glycol. In some aspects, the liquid composition comprises from about 20% by weight to about 25% by weight of a polyethylene glycol.

In some aspects, the liquid composition comprises about 10% by weight, about 15% by weight, about 20% by weight, about 25% by weight, about 30% by weight, about 35% by weight, about 40% by weight, about 45% by weight, about 50% by weight, about 55% by weight, about 60% by weight, or a range between any of two the preceding values, of a polyethylene glycol. In some aspects, the liquid composition comprises about 29% by weight of a polyethylene glycol. In some aspects, the liquid composition comprises about 35% by weight of a polyethylene glycol. In some aspects, the liquid composition comprises about 42% by weight of a polyethylene glycol.

In some aspects, the polyethylene glycol has a molecular weight between about 200 and about 1000 Daltons. In some aspects, the polyethylene glycol has a molecular weight between about 300 and about 1000 Daltons. In some aspects, the polyethylene glycol has a molecular weight between about 400 and about 1000 Daltons. In some aspects, the polyethylene glycol has a molecular weight between about 500 and about 1000 Daltons. In some aspects, the polyethylene glycol has a molecular weight between about 600 and about 1000 Daltons. In some aspects, the polyethylene glycol has a molecular weight between about 700 and about 1000 Daltons. In some aspects, the polyethylene glycol has a molecular weight between about 800 and about 1000 Daltons. In some aspects, the polyethylene glycol has a molecular weight between about 900 and about 1000 Daltons. In some aspects, the polyethylene glycol has a molecular weight between about 200 and about 900 Daltons. In some aspects, the polyethylene glycol has a molecular weight between about 200 and about 800 Daltons. In some aspects, the polyethylene glycol has a molecular weight between about 200 and about 700 Daltons. In some aspects, the polyethylene glycol has a molecular weight between about 200 and about 600 Daltons. In some aspects, the polyethylene glycol has a molecular weight between about 200 and about 500 Daltons. In some aspects, the polyethylene glycol has a molecular weight between about 200 and about 400 Daltons. In some aspects, the polyethylene glycol has a molecular weight between about 200 and about 300 Daltons. In some aspects, the polyethylene glycol has a molecular weight between about 300 and about 500 Daltons. In some aspects, the polyethylene glycol has a molecular weight between about 200 and about 400 Daltons. In some aspects, the polyethylene glycol has a molecular weight between about 400 and about 1000 Daltons.

In some aspects, the polyethylene glycol has a molecular weight of about 200 Daltons, about 300 Daltons, about 400 Daltons, about 500 Daltons, about 600 Daltons, about 700 Daltons, about 800 Daltons, about 900 Daltons, about 1000 Daltons, or a range between any two of the preceding values. In some aspects, the polyethylene glycol has a molecular weight of about 400 Daltons.

In some aspects, the liquid composition comprises from about 10% by weight to about 50% by weight of at least one non-aqueous solvent. In some aspects, the liquid composition comprises from about 8% by weight to about 40% by weight of at least one non-aqueous solvent. In some aspects, the liquid composition comprises from about 8% by weight to about 30% by weight of at least one non-aqueous solvent. In some aspects, the liquid composition comprises from about 10% by weight to about 30% by weight of at least one non-aqueous solvent. In some aspects, the liquid composition comprises from about 15% by weight to about 30% by weight of at least one non-aqueous solvent. In some aspects, the liquid composition comprises from about 20% by weight to about 30% by weight of at least one non-aqueous solvent. In some aspects, the liquid composition comprises from about 25% by weight to about 30% by weight of at least one non-aqueous solvent. In some aspects, the liquid composition comprises from about 8% by weight to about 25% by weight of at least one non-aqueous solvent. In some aspects, the liquid composition comprises from about 8% by weight to about 20% by weight of at least one non-aqueous solvent. In some aspects, the liquid composition comprises from about 8% by weight to about 15% by weight of at least one non-aqueous solvent. In some aspects, the liquid composition comprises from about 8% by weight to about 10% by weight of at least one non-aqueous solvent.

In some aspects, the liquid composition comprises about 8% by weight, about 10% by weight, about 15% by weight, about 20% by weight, about 25% by weight, about 30% by weight, about 35% by weight, about 40% by weight, about 45% by weight, about 50% by weight, about 55% by weight, about 60% by weight, or a range between any two of the preceding values, of at least one non-aqueous solvent. In some aspects, the liquid composition comprises about 15% of at least one non-aqueous solvent. In some aspects, the liquid composition comprises about 18% of at least one non-aqueous solvent. In some aspects, the liquid composition comprises about 32% of at least one non-aqueous solvent.

In some aspects, the liquid composition comprises from about 10% by weight to about 35% by weight of a first non-aqueous solvent. In some aspects, the liquid composition comprises from about 10% by weight to about 30% by weight of a first non-aqueous solvent. In some aspects, the liquid composition comprises from about 15% by weight to about 30% by weight of a first non-aqueous solvent. In some aspects, the liquid composition comprises from about 20% by weight to about 30% by weight of a first non-aqueous solvent. In some aspects, the liquid composition comprises from about 25% by weight to about 30% by weight of a first non-aqueous solvent.

In some aspects, the liquid composition comprises about 10% by weight, about 15% by weight, about 20% by weight, about 25% by weight, about 30% by weight, about 35% by weight, or a range between any two of the preceding values, of a first non-aqueous solvent. In some aspects, the liquid composition comprises about 18% of a first non-aqueous solvent. In some aspects, the liquid composition comprises about 22% of a first non-aqueous solvent. In some aspects, the liquid composition comprises about 24% of a first non-aqueous solvent.

In some aspects, the at least one non-aqueous solvent is selected from the group consisting of ethylene glycol, glycerin, propylene glycol, ethanol, dipropylene glycol, tripropylene glycol methyl ether, and combinations thereof. In some aspects, the liquid composition comprises a first non-aqueous solvent and a second non-aqueous solvent.

In some aspects, the first non-aqueous solvent is selected from the group consisting of ethylene glycol, glycerin, propylene glycol, ethanol, dipropylene glycol, tripropylene glycol methyl ether, and combinations thereof. In some aspects, the first non-aqueous solvent is glycerin. In some aspects, the first non-aqueous solvent is ethylene glycol. In some aspects, the first non-aqueous solvent is propylene glycol. In some aspects, the first non-aqueous solvent is ethanol. In some aspects, the first non-aqueous solvent is dipropylene glycol. In some aspects, the first non-aqueous solvent is tripropylene glycol methyl ether.

In some aspects, the liquid composition comprises from about 0% by weight to about 20% by weight of a second non-aqueous solvent. In some aspects, the liquid composition comprises from about 0% by weight to about 15% by weight of a second non-aqueous solvent. In some aspects, the liquid composition comprises from about 0% by weight to about 10% by weight of a second non-aqueous solvent. In some aspects, the liquid composition comprises from about 1% by weight to about 15% by weight of a second non-aqueous solvent. In some aspects, the liquid composition comprises from about 5% by weight to about 15% by weight of a second non-aqueous solvent. In some aspects, the liquid composition comprises from about 8% by weight to about 15% by weight of a second non-aqueous solvent. In some aspects, the liquid composition comprises from about 10% by weight to about 15% by weight of a second non-aqueous solvent. In some aspects, the liquid composition comprises from about 8% by weight to about 10% by weight of a second non-aqueous solvent.

In some aspects, the liquid composition comprises about 0% by weight, about 5% by weight, about 8% by weight, about 10% by weight, about 15% by weight, about 20% by weight, or a range between any two of the preceding values, of a second non-aqueous solvent. In some aspects, the liquid composition comprises about 8% of a second non-aqueous solvent. In some aspects, the liquid composition comprises about 9.7% of a second non-aqueous solvent.

In some aspects, the second non-aqueous solvent is selected from the group consisting of ethylene glycol, glycerin, propylene glycol, ethanol, dipropylene glycol, tripropylene glycol methyl ether, and combinations thereof. In some aspects, the second non-aqueous solvent is propylene glycol. In some aspects, the second non-aqueous solvent is glycerin. In some aspects, the second non-aqueous solvent is ethylene glycol. In some aspects, the second non-aqueous solvent is ethanol. In some aspects, the second non-aqueous solvent is dipropylene glycol. In some aspects, the second non-aqueous solvent is tripropylene glycol methyl ether.

In some aspects, the first non-aqueous solvent and second non-aqueous solvent are selected from the group consisting of ethylene glycol, glycerin, propylene glycol, ethanol, dipropylene glycol, and tripropylene glycol methyl ether. In some aspects, the first non-aqueous solvent is glycerin and the second non-aqueous solvent is propylene glycol.

In some aspects, the liquid composition does not separate into more than one layer for at least 24 hours, or one day, at room temperature. In some aspects, the liquid composition does not separate into more than one layer for at least 2 days at room temperature. In some aspects, the liquid composition does not separate into more than one layer for at least 3 days at room temperature. In some aspects, the liquid composition does not separate into more than one layer for about 24 hours, or one day, at room temperature. In some aspects, the liquid composition does not separate into more than one layer for about 2 days at room temperature. In some aspects, the liquid composition does not separate into more than one layer for about 3 days at room temperature.

In some aspects, provided herein is a fabric treatment unit dose product further comprising a second water-soluble compartment enclosing a solid composition. In some aspects, the solid composition is a powder composition. In some aspects, the powder composition is a cleaning composition. In some aspects, the powder composition is a scent booster. In some aspects, the powder composition comprises a cleaning composition and a scent booster. In spome aspects the cleaning composition can comprise one or more ingredients selected from surfactants, bleach, anti-redeposition polymers, optical brighteners, fragrance compositions, or combinations thereof.

The present application incorporates by reference entirely the disclosures of U.S. Pat. No. 8,497,234, US Patent Application Publication Nos. 20180371378, and U.S. patent application Ser. Nos. 16/231,269, 16/837,484, and 17/249,023.

Any examples provided herein are offered by way of illustration and not by way of limitation.

### EXAMPLES

### Example 1: Unit Dose Product with Polyethylene Glycol

Exemplary fabric treatment unit dose products as disclosed herein comprise at least one water-soluble compartment comprising a liquid composition. The liquid composition was prepared by overhead mixing at 50-800 rpm for about 15 minutes to an hour after all materials were added together. Three liquid compositions as disclosed herein (Composition 1, Composition 2, and Composition 3) were prepared with the ingredients and amounts as listed in Table 1 below.

TABLE 1
Formulations of liquid compositions

| | % Weight in Formula | | |
|---|---|---|---|
| | Composition | Composition | Composition |
| | 1 | 2 | 3 |
| Encapsulated Fragrance | 40 | 39 | 33.3 |
| PEG400 | 42 | 29 | 35 |
| Glycerin | 18 | 24 | 22 |
| Propylene glycol | 0 | 8 | 9.7 |

Composition 2 was compared to two reference samples (Reference 1 and Reference 2) in order to show the increased stability of Composition 2. The formulations of the three samples are shown in Table 2 below.

TABLE 2
Comparison

| | Weight % | | |
|---|---|---|---|
| | Reference | Reference | Composition |
| | 1 | 2 | 2 |
| Encapsulated Fragrance | 62% | 55% | 39% |
| Liquid Slurry | | | |
| Glycerin | 38% | 33% | 24% |
| Propylene glycol | | 12% | 8% |
| PEG400 | | | 29% |

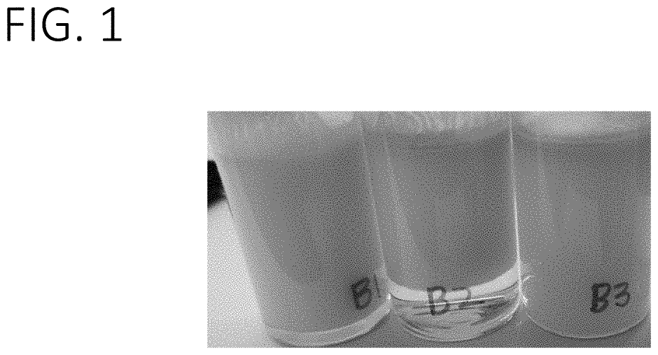

As shown in FIG. 1, by blending non-aqueous solvents with encapsulated fragrance, Reference 1 and Reference 2 showed separation already after incubation at room temperature for 24 hours. It was surprisingly found that the addition of PEG400 as seen in Composition 2 was able to significantly improve the stability and make it stable after incubation at room temperature for 24 hours. Composition 2 did not show any separation after the incubation period.

What is claimed is:

1. A fabric treatment unit dose product comprising:
a. at least one water-soluble compartment formed by a water-soluble film material, wherein the at least one water-soluble compartment comprises a liquid composition comprising:
i. (1) from about 20% by weight to about 50% by weight of an encapsulated fragrance slurry, or (2) from about 5% by weight to about 18% by weight of encapsulated fragrance particles;
ii. from about 8% by weight to about 40% by weight of at least one non-aqueous solvent; and
iii. from about 20% by weight to about 50% by weight of a polyethylene glycol, wherein the polyethylene glycol has a molecular weight between about 200 and about 1000 Daltons.

2. The fabric treatment unit dose product of claim 1, wherein the at least one non-aqueous solvent is selected from the group consisting of ethylene glycol, glycerin, propylene glycol, ethanol, dipropylene glycol, and tripropylene glycol methyl ether.

3. The fabric treatment unit dose product of claim 1, wherein the liquid composition comprises a first non-aqueous solvent and a second non-aqueous solvent, wherein the first non-aqueous solvent is glycerin.

4. The fabric treatment unit dose product of claim 3, wherein the second non-aqueous solvent is propylene glycol.

5. The fabric treatment unit dose product of claim 1, wherein the polyethylene glycol has a molecular weight of about 400 Daltons.

6. The fabric treatment unit dose product of claim 1, further comprising a second compartment, wherein the second compartment comprises a powder composition, and wherein the powder composition comprises a fragrance composition.

7. The fabric treatment unit dose product of claim 1, wherein the encapsulated fragrance slurry comprises from about 20% by weight to about 40% by weight of encapsulated fragrance particles.

8. A fabric treatment unit dose product comprising:
a. at least one water-soluble compartment formed by a water-soluble film material, wherein the at least one water-soluble compartment comprises a liquid composition comprising:
i. (1) from about 20% by weight to about 70% by weight of an encapsulated fragrance slurry, or (2) from about 5% by weight to about 25% by weight of encapsulated fragrance particles;
ii. from about 8% by weight to about 50% by weight of at least one non-aqueous solvent; and
iii. from about 10% by weight to about 60% by weight of a polyethylene glycol, wherein the polyethylene glycol has a molecular weight between about 200 and about 1000 Daltons.

9. The fabric treatment unit dose product of claim 8, wherein the at least one non-aqueous solvent is selected from the group consisting of ethylene glycol, glycerin, propylene glycol, ethanol, dipropylene glycol, and tripropylene glycol methyl ether.

10. The fabric treatment unit dose product of claim 8, wherein the liquid composition comprises a first non-aqueous solvent and a second non-aqueous solvent, wherein the first non-aqueous solvent is glycerin.

11. The fabric treatment unit dose product of claim 10, wherein the second non-aqueous solvent is propylene glycol.

12. The fabric treatment unit dose product of claim 8, wherein the polyethylene glycol has a molecular weight of about 400 Daltons.

13. The fabric treatment unit dose product of claim 8, further comprising a second compartment, wherein the second compartment comprises a powder composition, and wherein the powder composition comprises a fragrance composition.

14. The fabric treatment unit dose product of claim 13, wherein the encapsulated fragrance slurry comprises from about 20% by weight to about 40% by weight of encapsulated fragrance particle.

15. The fabric treatment unit dose product of claim 8, wherein the liquid composition does not separate into more than one layer for at least 24 hours at room temperature.

16. A liquid composition comprising:
a. (1) from about 20% by weight to about 45% by weight of an encapsulated fragrance slurry, or (2) from about 5% by weight to about 15% by weight of encapsulated fragrance particles;
b. from about 8% by weight to about 30% by weight of at least one non-aqueous solvent; and
c. from about 20% by weight to about 50% by weight of a polyethylene glycol, wherein the polyethylene glycol has a molecular weight between about 200 and about 1000 Daltons.

17. The liquid composition of claim 16, wherein the at least one non-aqueous solvent is selected from the group consisting of ethylene glycol, glycerin, propylene glycol, ethanol, dipropylene glycol, and tripropylene glycol methyl ether.

18. The liquid composition of claim 16, wherein the liquid composition comprises a first non-aqueous solvent and a second non-aqueous solvent, wherein the first non-aqueous solvent is glycerin.

19. The liquid composition of claim 18, wherein the second non-aqueous solvent is propylene glycol.

20. The liquid composition of claim 16, wherein the liquid composition does not separate into more than one layer for at least 24 hours at room temperature.
